(19) United States
(12) Patent Application Publication
(10) Pub. No.: US 2010/0136194 A1
(43) Pub. Date: Jun. 3, 2010

(54) STEAMER INSERT APPARATUS

(76) Inventor: William Christopher Schutte, Suwanee, GA (US)

Correspondence Address: GEORGE R. REARDON, 3356 STATION COURT, LAWRENCVILLE, GA, 30044, US

(21) Appl. No.: 12/701,575

(22) Filed: Feb. 7, 2010

Related U.S. Application Data
(63) Continuation-in-part of application No. 11/923,465, filed on Oct. 24, 2007.

(51) Int. Cl. A47J 27/04; A47J 43/00; A23L 1/00

(52) U.S. Cl. 426/510; 99/413; 99/450

(57) ABSTRACT

A steamer insert apparatus is disclosed. The steamer insert apparatus includes a steaming platform. The steaming platform is generally round and configured to self-adjust and to suspend from a rim of a cooking pot. The steaming platform is located within the cooking pot in a suspended manner to provide a surface area on which to place a first food item for steaming. The steamer insert apparatus includes an operably coverable opening defined in the steaming platform and through which to access a second food item to cook in water located below the steaming platform. In at least one embodiment, steaming platform includes a pair of risible extensions. A food item larger in diameter than the cooking pot can be placed upon the risible extensions.

### CROSS-REFERENCE TO RELATED APPLICATION(S)

This present non-provisional patent application is a continuation-in-part of copending U.S. patent application Ser. No. 11/923,465, filed on Oct. 24, 2007, and entitled “STEAMER INSERT APPARATUS” and of which the application cited above is incorporated in-full by reference herein.

### FIELD OF THE INVENTION

The technology disclosed herein relates generally to inserts for kitchen pots. More particularly, the technology disclosed herein relates to an insert for a kitchen pot that facilitates the steaming of a first food item on an insert while providing access for inserting and retrieving a second food item into boiling water in the pot.

### BACKGROUND OF THE INVENTION

A hot dog is a type of fully-cooked, cured and/or smoked moist sausage of soft, even texture and flavor. It is usually placed hot in a soft, sliced bun of approximately the same length as the sausage, and optionally garnished with condiments and toppings.

During home preparation hot dogs are traditionally boiled in a pot of boiling water until the hot dogs become plump. A long standing problem has been how to warm up the hot dog buns so that the boiled hot dog is not placed into a cold bun.

One solution offered commercially is an electrical device having a hot dog recess and a hot dog bun recess. The user inserts the hot dog into the hot dog recess and the hot dog bun into the hot dog bun recess; plugs in the device to an electrical receptacle and activates the device. One brand allows the grilling of up to five hot dogs and the warming of two buns simultaneously. Problems associated with this solution include: its price (suggested retail of $49.95; some users do not want their hot dogs grilled; some users prefer their buns soft, not toasted and crunchy. What is needed is a device that is more economically priced and produces hot dogs that are not grilled and buns that are not toasted and crunchy.

Related patents known in the background art include the following: U.S. Pat. No. 3,782,664, issued to Bennett on Aug. 8, 1972, discloses a bun warmer and steamer and hotdog cooker.

U.S. Pat. No. 4,052,934, issued to Shinman on Oct. 11, 1977, discloses a device for attachment to a frying pan, cooking pot or like cooking utensil. The device comprises an openwork substantially flat metal base of circular segment shape, a flange upstanding from the circumference of the base and support means located at or near the circumference of the base for supporting the device on the rim of the cooking utensil in an easily attachable and detachable manner.

U.S. Pat. No. 4,332,189, issued to Stuck on Jun. 1, 1982, discloses an apparatus and method for preparing foodstuffs, and particularly sausages and buns such as hot dogs. A reservoir containing heated water is provided and sausages are immersed in and moved through the heated water by a conveyor while buns are moved through heated vapor from the heated water to heat the sausages and buns to a desired serving temperature.

U.S. Pat. No. 4,677,905, issued to Johnson on Jul. 7, 1987, discloses a food heating apparatus placeable over boiling water, the apparatus comprising a plate including a generally planar upper surface and a lower surface generally parallel to the upper surface, the plate having therethrough a plurality of steam passages extending between the lower surface and the upper surface, each of the steam passages communicating with the upper surface through a first opening having a first area and communicating with the lower surface through a second opening having a second area substantially greater than the first area.

U.S. Pat. No. 5,195,424, issued to Guajaca on Mar. 23, 1993, discloses a steamer for tamales and other comestibles having a rack capable of supporting foods being cooked therein at an inclined orientation. The rack is provided with a number of horizontal tiers or assemblies each constructed of rings joined by radially positioned spokes. Corresponding rings within each of the rack's assemblies increase in size from the top to the bottom of the rack establishing conically shaped surfaces upon which comestibles may be positively supported at an incline. The spokes connecting the rings of each of the assemblies are vertically oriented one above the other and divide the rack into separate receptacles for segregating foods during cooking. Two or more racks may be stacked within the steamer's open-topped vessel thereby increasing its cooking capacity.

U.S. Pat. No. D341, 990, issued to Yim on Dec. 7, 1993, illustrates a steamer basket for a food steamer.

U.S. Pat. No. 5,913,966, issued to Armone et al. on Jun. 22, 1999, discloses an improved pan that can also be used as a steaming utensil on top of an ordinary pot; the pan comprises a receptacle that has a flat bottom and a side wall whose top edge has a chord-truncated circular shape and a flange. The area defined by the chord-truncated circular shape is made as large as desired without voiding access to the pot below and without increasing the predetermined radius of the receptacle. The above preferred embodiment can also have a multiplicity of holes in the bottom. The preferred embodiment is not restricted to an outer pot of given radius; it can be used on top of a variety of pots with radii within a determined range. The combination of the pan and the pot below behaves effectively as a double-compartment vessel. If the lid of the pot below is placed on top of the flange, the steam is substantially diverted toward the receptacle. Thus, the non-perforated preferred embodiment supersedes conventional pans and steamers by giving substantially identical performance thereover while additionally having: (a) a unique, eye-catching design, (b) the functionality of a double-boiler (careful heating of sauces or steaming of vegetables in the receptacle while boiling another substance in the pot below), and (c) an optimal capacity without voiding access to the pot below. In spite of its novel form, all the above multi-functionality is embedded within the familiar shape of a pan. The simple, yet unique, design of the invention, together with its universality of use, has important implications for the marketing of cookware sets whose pan of smallest capacity has been substituted by the pan of the present invention.

U.S. Pat. No. 6,443,053, issued to Rossi on Sep. 3, 2002, discloses a cooking element for a steamer, composed of: a tubular side wall; a removable perforated bottom, the tubular side wall having an interior surface provided with a shoulder on which the perforated bottom rests; a first element carried by the interior surface of the tubular side wall; and a second element carried by, and located beneath, the perforated bottom. The first element is located to block the second element when the perforated bottom rests on the shoulder, one of the elements is a tongue, and the other of the elements is an abutment. A cooking element for a steamer, composed of a tubular side wall, a removable perforated bottom and a removable handle, wherein the perforated bottom has orifices adapted for rapid connection of the removable handle.

U.S. Pat. No. D528,377, issued to Pippel et al., illustrates a cookware steamer grater.

While these patents and other previous methods have attempted to solve the problems that they addressed, none have utilized or disclosed a steamer insert apparatus that facilitates the steaming of hot dog buns during the hot dog boiling process, that is formed for convenient insertion and retrieval of hot dogs through an opening in the insert, that has pivoting handles that position the insert within the kitchen pot while providing for the placement of the pot lid on a corresponding place on the handles, as does embodiments of the technology disclosed herein. Furthermore, these patents and other previous methods have not disclosed grill risible extensions and movable grates.

Therefore, a need exists for a steamer insert apparatus with these attributes and functionalities. The steamer insert apparatus according to embodiments of the invention substantially departs from the conventional concepts and designs of the prior art. It can be appreciated that there exists a continuing need for a new and improved steamer insert apparatus which can be used commercially. In this regard, the technology disclosed herein substantially fulfills these objectives.

The foregoing patent and other information reflect the state of the art of which the inventor is aware and are tendered with a view toward discharging the inventor's acknowledged duty of candor in disclosing information that may be pertinent to the patentability of the technology described herein. It is respectfully stipulated, however, that the foregoing patent and other information do not teach or render obvious, singly or when considered in combination, the inventor's claimed invention.

### BRIEF SUMMARY OF THE INVENTION

In various exemplary embodiments, the technology described herein provides a steamer insert that releasably attaches to a cooking container, e.g. a kitchen pot. The steamer insert has an opening that is dimensioned for insertion and retrieval of at least one hot dog through the insert into boiling water in the cooking container, where the top of the boiling water is positioned below the bottom of the insert. The steamer insert has pivoting handles that: fold for compact storage of the insert; adapt to different diameter pots; and accommodate the placement of the pot lid on the handles.

In one exemplary embodiment, the technology described herein provides a steamer insert apparatus. The steamer insert apparatus includes a steaming platform. The steaming platform is generally round and configured to self-adjust and to suspend from a rim of a cooking pot. The steaming platform is located within the cooking pot in a suspended manner to provide a surface area on which to place a first food item for steaming. The steamer insert apparatus includes an operably coverable opening defined in the steaming platform and through which to access a second food item to cook in water located below the steaming platform.

The steamer insert apparatus also includes at least one risible extension. The risible extension is connected to the steaming platform to pivot from the steaming platform and lift upwardly and remain upright above the operably coverable opening. A food item larger in diameter than the cooking pot can be placed upon the risible extension. In at least one embodiment, the use of extensions includes a pair of risible extensions connected to the steaming platform. Each of the pair is offset one from another by approximately ninety degrees to pivot from the steaming platform and lift upwardly and remain upright above the operably coverable opening. An interlock notch is defined in each of the pair of risible extensions such that when both risible extensions are lifted into the upright position, the interlock notches hold the risible extensions in place one to another. A food item larger in diameter than the cooking pot can be placed upon a risible extension or the pair of risible extensions.

The steamer insert apparatus also includes a multiplicity of grill grates. The grill grates include at least a portion of operably movable grates, such that the movable grates are operably moveable to cover and uncover the operably coverable opening. Additionally, the operably coverable opening is configured to receive a dish containing a heatable item within the cooking pot and within the operably coverable opening of the steaming platform to heat the heatable item within the dish. In at least one embodiment, the operably coverable opening with which to access the second food item cooking below the steaming platform is shaped generally in the form of a key hole, thereby allowing the second food item in the cooking pot to pass through a first portion of the key-hole-shaped area while being grasped by a cooking utensil, the cooking utensil passing through a second portion of the key-hole-shaped area.

The steamer insert apparatus also includes a plurality of support legs, hingedly connected to the steaming platform, to suspend the steaming platform inside the cooking pot from the rim. Each of the plurality of support legs hingedly connected to the steaming platform is freely rotatable in order to be inserted into a plurality of cooking pots varied in size and diameter.

The steamer insert apparatus also includes a plurality of handles, each handle defined by a connection of a pair of the plurality of support legs, wherein the plurality of support legs are grouped in pairs, each pair collectively forming the handle by which the steaming platform is lifted in and out of the cooking pot. The handles can be covered with a heat abatement material to provide a grip area for a user when the steamer insert apparatus is heated. The steamer insert apparatus also includes a plurality of hooks, each hook defined at an upper end of each of the plurality of support legs, wherein the hook is configured to suspend from the rim of the cooking pot.

The steamer insert apparatus also includes a plurality of lid resting arms, each lid resting arm defined at an upper end of each of the plurality of support legs and facing inwardly when placed in the cooking pot, wherein the plurality of lid resting arms collectively provide a place upon which to rest a lid of the cooking pot, and wherein the placement of the lid upon the plurality of lid resting arms prevents the cooking pot and lid from touching directly and provides a vent area between the cooking pot and the lid.

In another exemplary embodiment, the technology described herein provides a method for steaming a first food item in a suspended manner in a cooking pot that is used to cook a second food item. The method includes: utilizing a steamer insert apparatus comprising a steaming platform, the steaming platform being generally round and configured to self-adjust and to suspend from a rim of a cooking pot, the steaming platform being located within the cooking pot in a suspended manner to provide a surface area on which to place a first food item for steaming; and an operably coverable opening defined in the steaming platform and through which to access a second food item to cook in water located below the steaming platform; placing the steaming platform within the cooking pot; placing a second food item within the cooking pot by passing the second food item through the operably coverable opening of the steaming platform; heating the water in the cooking pot to cook the second food item and to create steam to rise to the steaming platform; placing a first food item upon the steaming platform so that it will be steamed; and removing the second food item, once cooked, through the operably coverable opening in the steaming platform.

The method also includes: utilizing at least one risible extension, wherein the steamer insert apparatus further comprises at least one risible extension connected to the steaming platform to pivot from the steaming platform and lift upwardly and remain upright above the operably coverable opening and upon which to place the first food item when the first food item is larger in diameter than the cooking pot; raising the at least one risible extension; and placing the first food item upon the steaming platform and over the at least one risible extension so that it will be steamed.

The method also includes: utilizing a pair of risible extensions connected to the steaming platform, offset one from another by approximately ninety degrees to pivot from the steaming platform and lift upwardly and remain upright above the operably coverable opening and upon which to place the first food item when the first food item is larger in diameter than the cooking pot; utilizing an interlock notch defined in each of the pair of risible extensions such that when both risible extensions are lifted into the upright position, the interlock notches hold the risible extensions in place one to another; raising the pair of risible extensions; interlocking the pair of risible extensions with the interlock notch defined in each of the pair of risible extensions; and placing the first food item upon the steaming platform and over the pair of risible extensions so that it will be steamed.

The method can also include: placing a dish containing a heatable item in the operably coverable opening of the cooking pot, wherein the operably coverable opening is configured to receive the dish containing the heatable item within the cooking pot and within the operably coverable opening of the steaming platform to heat the heatable item within the dish.

The method can also include: covering the operably coverable opening, wherein the steaming platform is comprised of a plurality of grill grates, and wherein the plurality of plurality of grill grates includes at least a portion of operably movable grates, such that the movable grates are operably moveable to cover and uncover the operably coverable opening.

In yet another exemplary embodiment, the technology described herein provides an adjustable steaming grill. The adjustable steaming grill includes: a steaming platform, the steaming platform being generally round and configured to self-adjust and to suspend from a rim of a cooking pot, the steaming platform being located within the cooking pot in a suspended manner to provide a surface area on which to place a first food item for steaming; an operably coverable opening defined in the steaming platform and through which to access a second food item to cook in water located below the steaming platform; a pair of risible extensions connected to the steaming platform, offset one from another by approximately ninety degrees to pivot from the steaming platform and lift upwardly and remain upright above the operably coverable opening and upon which to place the first food item when the first food item is larger in diameter than the cooking pot; and an interlock notch defined in each of the pair of risible extensions such that when both risible extensions are lifted into the upright position, the interlock notches hold the risible extensions in place one to another.

The adjustable steaming grill also includes: a plurality of support legs, hingedly connected to the steaming platform, to suspend the steaming platform inside the cooking pot from the rim; a plurality of handles, each handle defined by a connection of a pair of the plurality of support legs, wherein the plurality of support legs are grouped in pairs, each pair collectively forming the handle by which the steaming platform is lifted in and out of the cooking pot; a plurality of hooks, each hook defined at an upper end of each of the plurality of support legs, wherein the hook is configured to suspend from the rim of the cooking pot; a plurality of lid resting arms, each lid resting arm defined at an upper end of each of the plurality of support legs and facing inwardly when placed in the cooking pot, wherein the plurality of lid resting arms collectively provide a place upon which to rest a lid of the cooking pot, and wherein the placement of the lid upon the plurality of lid resting arms prevents the cooking pot and lid from touching directly and provides a vent area between the cooking pot and the lid; and a heat abatement material disposed upon the plurality of handles to provide a grip area for a user when the steamer insert apparatus is heated.

Advantageously, the apparatus and associated methods disclosed herein provide a steamer insert to simultaneously steam a first food item and boil a second food item in the same cooking pot. Also advantageously, the steamer insert provides for the steaming of a food item that have a larger diameter than the cooking pot, such as a tortilla, in which the food item is steamed by utilizing the risible extensions. Further advantageously, the steamer insert provides for the heating of a food item in a dish placed within and supported from the operably coverable opening on the steaming platform. Still further advantageously, the steamer insert provides for the closing and opening of the operably coverable opening. Yet still further advantageously, the steamer insert provides for handles shaped such that a venting area is creating between the cooking pot and its lid while the steamer apparatus is placed within the cooking pot.

There has thus been outlined, rather broadly, the more important features of the technology in order that the detailed description thereof that follows may be better understood, and in order that the present contribution to the art may be better appreciated. There are additional features of the technology that will be described hereinafter and which will form the subject matter of the claims appended hereto. In this respect, before explaining at least one embodiment of the technology in detail, it is to be understood that the invention is not limited in its application to the details of construction and to the arrangements of the components set forth in the following description or illustrated in the drawings. The technology described herein is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the technology described herein. It is important, therefore, that the claims be regarded as including such equivalent constructions insofar as they do not depart from the spirit and scope of the technology described herein.

Further objects and advantages of the technology described herein will be apparent from the following detailed description of a presently preferred embodiment which is illustrated schematically in the accompanying drawings.

### BRIEF DESCRIPTION OF THE DRAWINGS

The technology described herein is illustrated with reference to the various drawings, in which like reference numbers denote like device components and/or method steps, respectively, and in which:

FIG. 1 is a perspective view of a steamer insert apparatus, illustrating, in particular, the grill risible extensions in a raised configuration, according to an embodiment of the technology described herein;

FIG. 2 is a bottom view of the steamer insert apparatus depicted in FIG. 1, illustrating, in particular, the and the self-adjusting handles, according to an embodiment of the technology described herein;

FIG. 3 is a side view of the steamer insert apparatus depicted in FIG. 1, according to an embodiment of the technology described herein;

FIG. 4 is an side view of the steamer insert apparatus depicted in FIG. 1, ninety degrees offset from the side view depicted in FIG. 3;

FIG. 5 is a top view of the steamer insert apparatus depicted in FIG. 1, illustrating, in particular, the grill risible extensions in a raised configuration, according to an embodiment of the technology described herein;

FIG. 6 is a perspective view of the steamer insert apparatus steamer insert apparatus depicted in FIG. 1, illustrating, in particular, the grill risible extensions in a folded position, according to an embodiment of the technology described herein; and

FIG. 7 is a close-up perspective view of the steamer insert apparatus depicted in FIG. 1, illustrating, in particular, the handles and insulations sleeves, according to an embodiment of the technology described herein.

### DETAILED DESCRIPTION OF THE INVENTION

Before describing the disclosed embodiments of this technology in detail, it is to be understood that the technology is not limited in its application to the details of the particular arrangement shown here since the technology described is capable of other embodiments. Also, the terminology used herein is for the purpose of description and not of limitation.

In various exemplary embodiments, the technology described herein provides a steamer insert that releasably attaches to a cooking container, e.g. a kitchen pot. The steamer insert has an opening that is dimensioned for insertion and retrieval of at least one food item through the insert into boiling water in the cooking container, where the top of the boiling water is positioned below the bottom of the insert. The steamer insert has pivoting handles that: fold for compact storage of the insert; adapt to different diameter pots; and accommodate the placement of the pot lid on the handles.

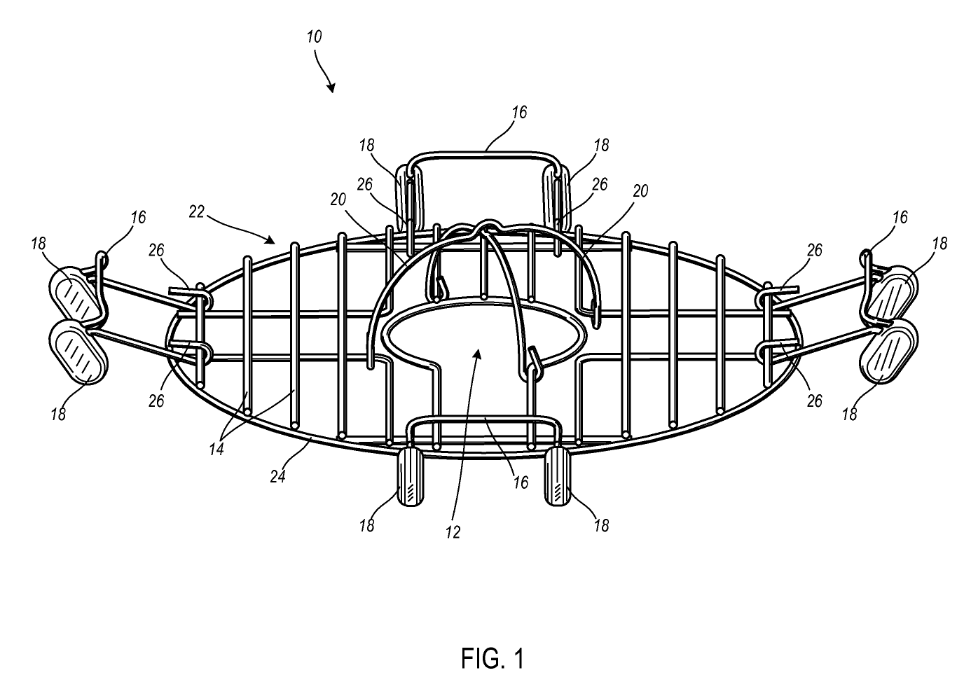

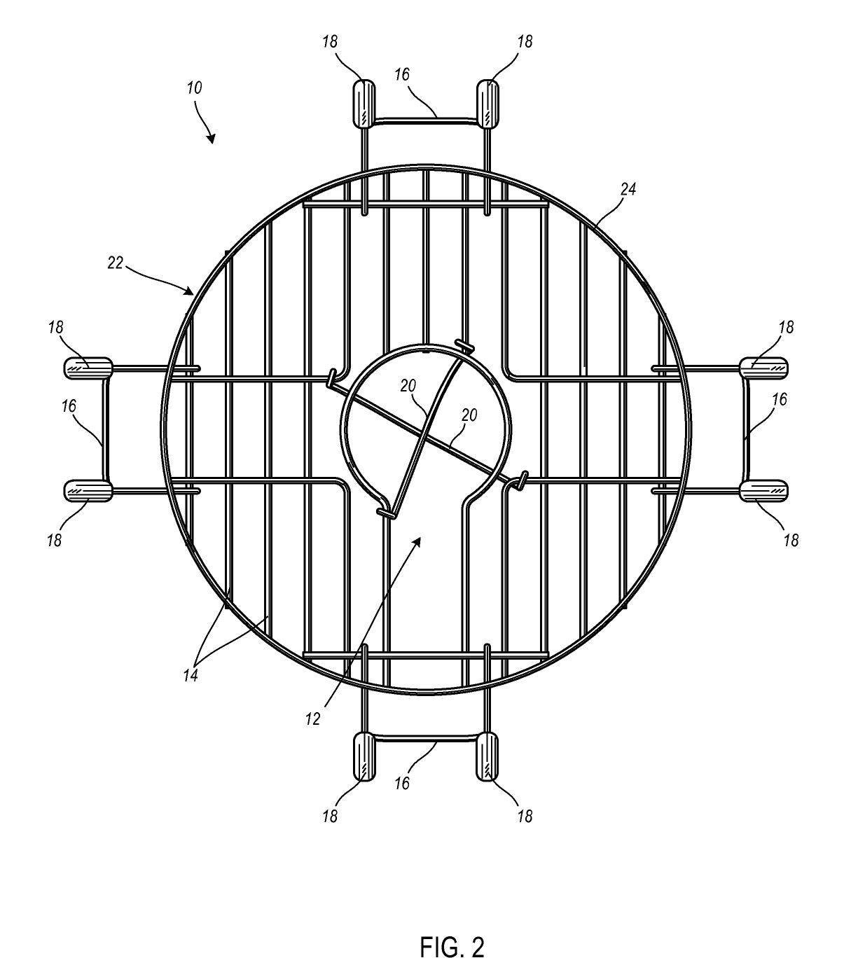

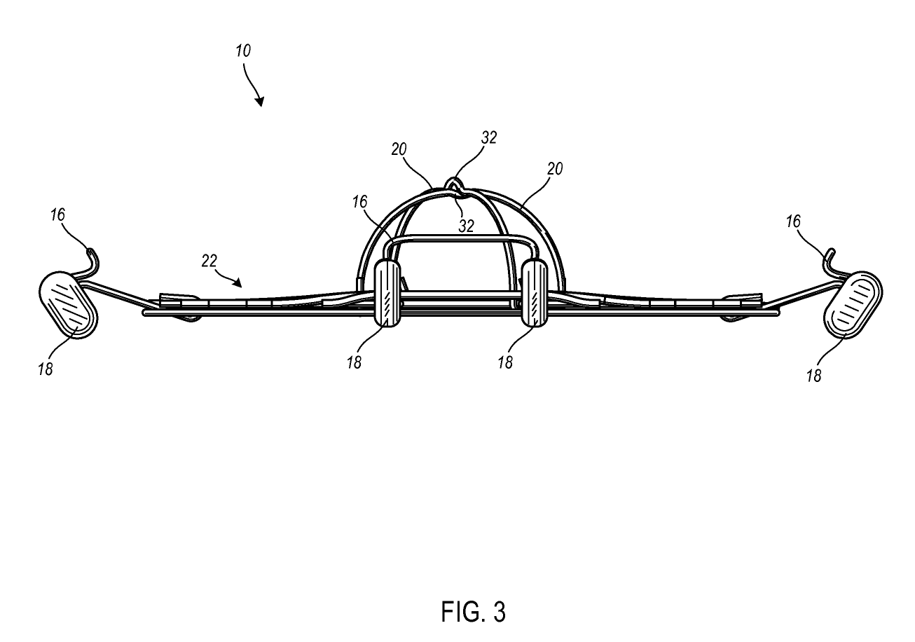

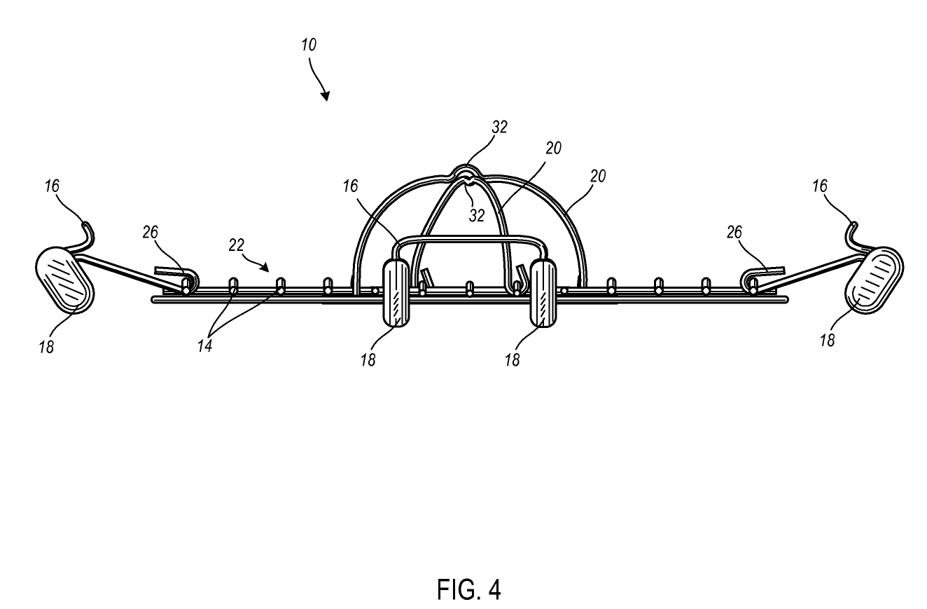

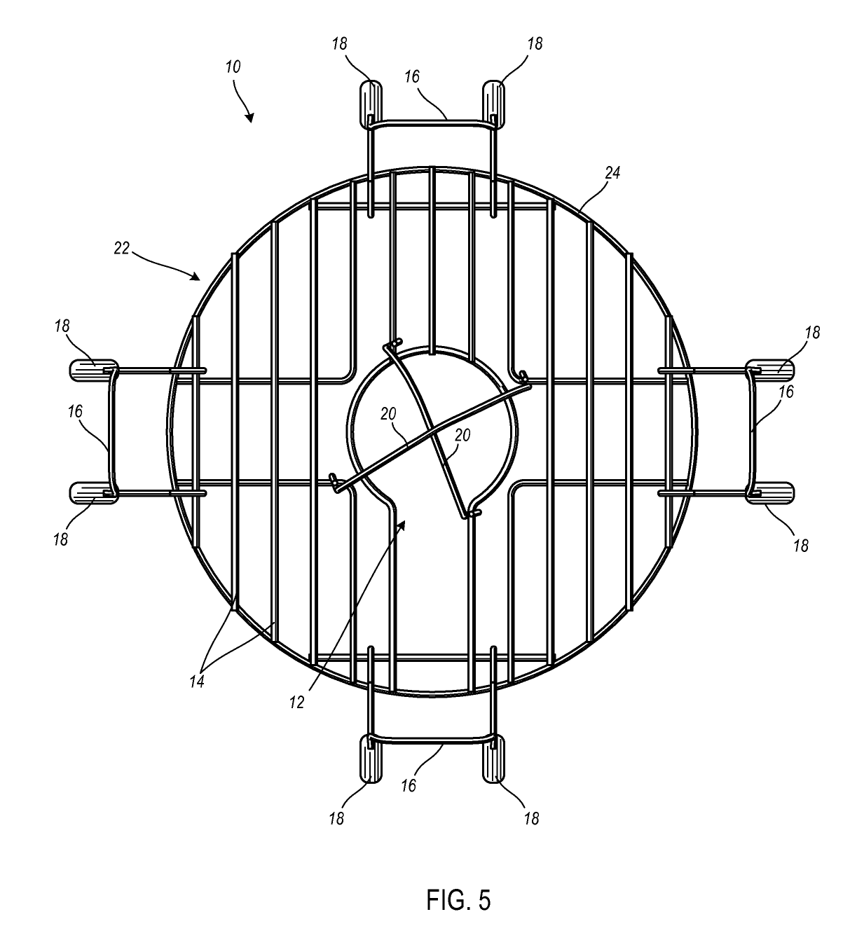

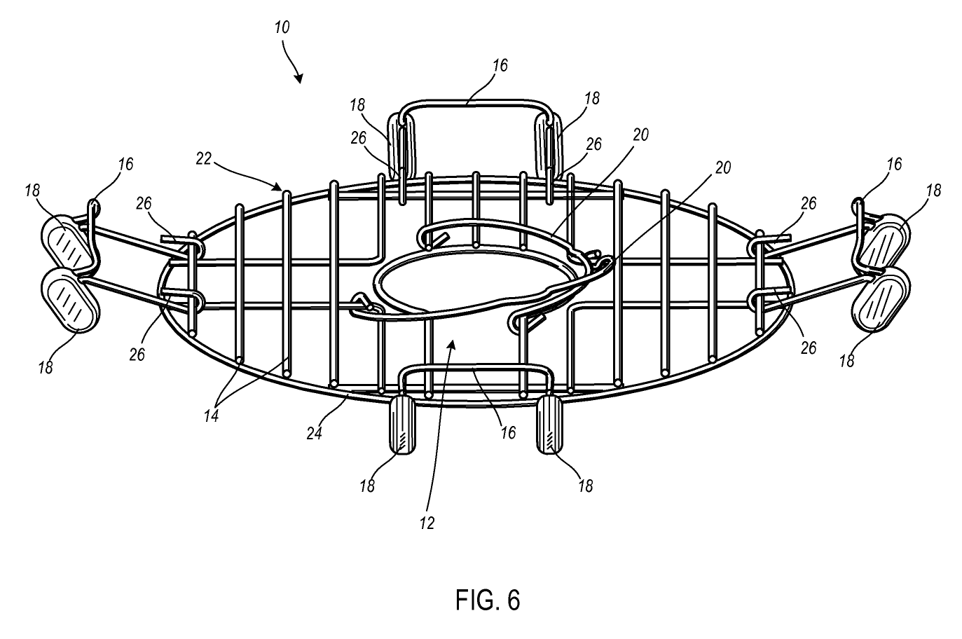

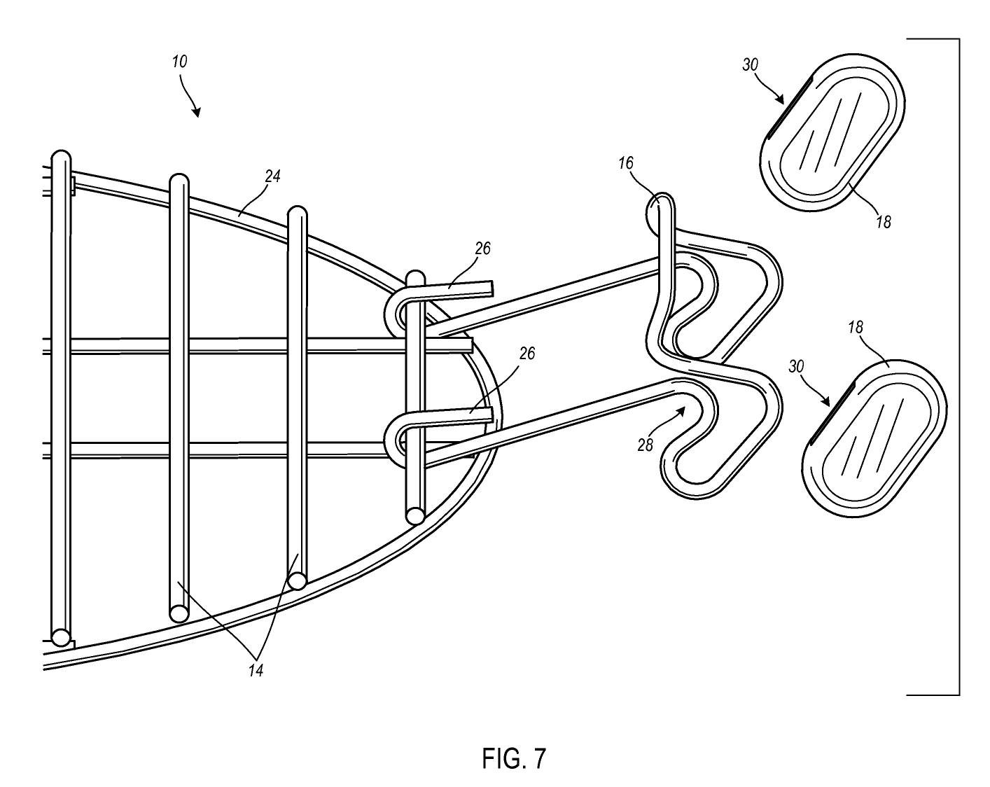

Referring now to FIGS. 1 to 7, and in various exemplary embodiments, the technology described herein provides a steamer insert apparatus 10. The steamer insert apparatus 10 includes steaming platform 22. The steaming platform 22 is generally round and configured to self-adjust and to suspend from a rim of a cooking pot (not shown). The steaming platform 22 is located within the cooking pot in a suspended manner to provide a surface area on which to place a first food item for steaming. By way of example, the steaming platform 22 is utilized to steam hot dog buns, tortillas, and other food items. Also, by way example, the steaming platform 22 can be constructed of a metal, such as stainless steel, such that it is safe for use in the preparation of food items. Other materials can be utilized so long as they are durable, can withstand heat of steam and boiling water, and are safe for use in the preparation of food items.

The steamer insert apparatus 10 includes an operably coverable opening 12 defined in the steaming platform 22. While a first food item placed upon the steaming platform 22 is steamed, a second food item is cooked in the cooking pot in water located below the steaming platform 22. By way of example, the first food item can be a hot dog bun steamed on the steaming platform 22 while the second food item is a hot dog boiled in the water below the steaming platform 22. Other food combinations in which one portion is to be boiled and another portion to be steamed can be cooked utilizing the steamer insert apparatus 10, allowing both items to be cooked simultaneously in one cooking pot. Access to the second food item is provided through the operably coverable opening 12. Access through the operably coverable opening 12 can be made by tongs, a fork, and the like.

The steamer insert apparatus 10 also includes at least one risible extension 20. The risible extension 20 is, for example, hingedly connected to the steaming platform 22 to pivot from the steaming platform 22 and lift upwardly to remain upright above the operably coverable opening 12. When not in use, the risible extension 20 can be folded downwardly for storage. A food item larger in diameter than the cooking pot can be placed upon the risible extension 20. The risible extension 20 is designed to be operable single-handedly. As depicted in the Figures, the risible extension 20 is of a shape generally resembling an arc. However, variations in the shape of the risible extension 20 are contemplated to address the variations in types, sizes, shapes, etc. of food items placed upon the steaming platform 22.

In at least one embodiment, the use of extensions 20 includes a pair of risible extensions 20 independently connected to the steaming platform 20. Each of the pair is offset one from another by approximately ninety degrees, for example, to pivot from the steaming platform 22 and lift upwardly and remain upright above the operably coverable opening 12. When not in use, the risible extensions 20 can be unconnected one from another and folded downwardly for storage.

An interlock notch 32 is defined in each of the pair of risible extensions 20 such that when both risible extensions 20 are lifted into the upright position, the interlock notches 32 hold the risible extensions 20 in place one to another. A food item larger in diameter than the cooking pot, such as a large tortilla, or the like, can be placed upon a single risible extension 20 or the pair of risible extensions 20. By way of example, when a pair of risible extensions 20 is employed, one can have a concave notch and the other a convex notch such that the notches 32 can easily interlock. The notches 32 are designed to be operable single-handedly to interlock the pair of risible extensions 20.

The steamer insert apparatus also includes a multiplicity of grill grates 14, located generally parallel one to another and connected, either permanently or flexibly, at each end to a circumference 24 of the steaming platform 22. The grill grates 14 include at least a portion of operably movable grates 14, such that the movable grates 14 are operably moveable to cover and uncover the operably coverable opening 12. By way of example, grill grates 14 can be moved and pivoted about the circumference 24 of the steaming platform 22 to cover temporarily the operably coverable opening 12.

The steaming platform 22 is configured to receive, within the operably coverable opening 12, a dish containing a heatable item within the cooking pot to heat the heatable item within the dish. By way of example, the heatable item in the dish can be a dipping sauce, or the like, that is best served heated. When hot dogs and hot dog buns are cooked and steamed, respectively, in the cooking pot, a chili sauce, or the like, for chili dogs can be heating in this manner.

In at least one embodiment, the operably coverable opening 12 with which to access the second food item cooking below the steaming platform 22 is shaped generally in the form of a key hole. The key-hole shape thereby allows the second food item in the cooking pot to pass through a first portion of the key-hole area while being grasped by a cooking utensil, the cooking utensil passing through a second portion of the key-hole-shaped area.

The steamer insert apparatus 10 also includes a plurality of support legs 26, hingedly connected to the steaming platform 22. The plurality of support legs 26 is configured to suspend the steaming platform 22 inside the cooking pot from the rim. Each of the plurality of support legs 26 hingedly connected to the steaming platform 22 is freely rotatable in order to be inserted into a plurality of cooking pots varied in size and diameter.

The steamer insert apparatus 10 also includes a plurality of handles 16. Each handle 16 is defined by a connection of a pair of the plurality of support legs 26. In at least one embodiment, the plurality of support legs 26 is grouped in pairs. Each pair of support legs 26 collectively forms a handle 16 by which the steaming platform 22 is lifted in and out of the cooking pot. A shown in the Figures, four handles 16 are available from the pairing of eight support legs 26. Other combinations of the plurality of support legs 26 can be utilized to form handles 16.

The handles 16 can be covered with a heat abatement material to provide a grip area for a user when the steamer insert apparatus 10 is heated. This prevents a user from burning his or her fingers when grasping a heated steamer insert apparatus 10 for removal from the cooking pot or adjustment within the cooking pot. By way of example, the heat abatement material also can include a silicone insulation sleeve 18. In at least one embodiment, the silicone insulation sleeves 18 each have a sleeve opening into which the hook 28 formation defined between each support leg 26 and handle 16 is placed. The silicone insulation sleeves 18 also provide a place in which a user can grasp the steamer insert apparatus 10 without getting burned.

The steamer insert apparatus 10 also includes a plurality of hooks 28. Each hook 28 is defined at an upper end of each of the plurality of support legs 26 before the handle 26 portion. Each hook 28 defines an arc radius designed to fit over the rim of cooking pots in a variety of sizes and thicknesses. The hook 28 is configured to suspend from the rim of the cooking pot and provide a level steaming surface for the steaming platform 22.

The steamer insert apparatus also includes a plurality of lid resting arms. Each lid resting arm is defined as part of the handle 16 at an upper end of each of the plurality of support legs 26. The lid resting arms face inwardly when placed in the cooking pot. The lid resting arms collectively provide a place upon which to rest a lid of the cooking pot. The placement of the lid upon the plurality of lid resting arms prevents the cooking pot and lid from touching directly and provides a vent area between the cooking pot and the lid. Excess steam, for example, can vent through the vent area.

A method for steaming a first food item in a suspended manner in a cooking pot that is used to cook a second food item, and utilizing a steamer insert apparatus as previously defined, can include the following method steps entirely, as a subset, and in variable order as needed and desired based on a particular cooking application: placing the steaming platform within the cooking pot; placing a second food item within the cooking pot by passing the second food item through the operably coverable opening of the steaming platform; heating the water in the cooking pot to cook the second food item and to create steam to rise to the steaming platform; placing a first food item upon the steaming platform so that it will be steamed; removing the second food item, once cooked, through the operably coverable opening in the steaming platform; raising the at least one risible extension; placing the first food item upon the steaming platform and over the at least one risible extension so that it will be steamed; raising the pair of risible extensions; interlocking the pair of risible extensions with the interlock notch defined in each of the pair of risible extensions; placing the first food item upon the steaming platform and over the pair of risible extensions so that it will be steamed; placing a dish containing a heatable item in the operably coverable opening of the cooking pot; and covering the operably coverable opening.

Although this technology has been illustrated and described herein with reference to preferred embodiments and specific examples thereof, it will be readily apparent to those of ordinary skill in the art that other embodiments and examples can perform similar functions and/or achieve like results. All such equivalent embodiments and examples are within the spirit and scope of the technology described herein and are intended to be covered by the following claims.

What is claimed is:

1. A steamer insert apparatus comprising:
a steaming platform, the steaming platform being generally round and configured to self-adjust and to suspend from a rim of a cooking pot, the steaming platform being located within the cooking pot in a suspended manner to provide a surface area on which to place a first food item for steaming; and
an operably coverable opening defined in the steaming platform and through which to access a second food item to cook in water located below the steaming platform.

2. The steamer insert apparatus of claim 1, further comprising:
at least one risible extension connected to the steaming platform to pivot from the steaming platform and lift upwardly and remain upright above the operably coverable opening and upon which to place the first food item when the first food item is larger in diameter than the cooking pot.

3. The steamer insert apparatus of claim 1, further comprising:
a pair of risible extensions connected to the steaming platform, offset one from another by approximately ninety degrees to pivot from the steaming platform and lift upwardly and remain upright above the operably coverable opening and upon which to place the first food item when the first food item is larger in diameter than the cooking pot.

4. The steamer insert apparatus of claim 4, further comprising:
an interlock notch defined in each of the pair of risible extensions such that when both risible extensions are lifted into the upright position, the interlock notches hold the risible extensions in place one to another.

5. The steamer insert apparatus of claim 1, wherein the steaming platform is comprised of a plurality of grill grates.

6. The steamer insert apparatus of claim 5, wherein the plurality of plurality of grill grates includes at least a portion of operably movable grates, such that the movable grates are operably moveable to cover and uncover the operably coverable opening.

7. The steamer insert apparatus of claim 1, wherein the operably coverable opening is configured to receive a dish containing a heatable item within the cooking pot and within the operably coverable opening of the steaming platform to heat the heatable item within the dish.

8. The steamer insert apparatus of claim 1, wherein the operably coverable opening with which to access the second food item cooking below the steaming platform is shaped generally in the form of a key hole, thereby allowing the second food item in the cooking pot to pass through a first portion of the key-hole-shaped area while being grasped by a cooking utensil, the cooking utensil passing through a second portion of the key-hole-shaped area.

9. The steamer insert apparatus of claim 1, further comprising:
a plurality of support legs, hingedly connected to the steaming platform, to suspend the steaming platform inside the cooking pot from the rim; and
a plurality of handles, each handle defined by a connection of a pair of the plurality of support legs, wherein the plurality of support legs are grouped in pairs, each pair collectively forming the handle by which the steaming platform is lifted in and out of the cooking pot.

10. The steamer insert apparatus of claim 9, further comprising:
a plurality of hooks, each hook defined at an upper end of each of the plurality of support legs, wherein the hook is configured to suspend from the rim of the cooking pot.

11. The steamer insert apparatus of claim 9, further comprising:
a plurality of lid resting arms, each lid resting arm defined at an upper end of each of the plurality of support legs and facing inwardly when placed in the cooking pot, wherein the plurality of lid resting arms collectively provide a place upon which to rest a lid of the cooking pot, and wherein the placement of the lid upon the plurality of lid resting arms prevents the cooking pot and lid from touching directly and provides a vent area between the cooking pot and the lid.

12. The steamer insert apparatus of claim 9, further comprising:
a heat abatement material disposed upon the plurality of handles to provide a grip area for a user when the steamer insert apparatus is heated.

13. The steamer insert apparatus of claim 9, wherein the plurality of support legs hingedly connected to the steaming platform are freely rotatable in order to be inserted into a plurality of cooking pots varied in size and diameter.

14. A method for steaming a first food item in a suspended manner in a cooking pot that is used to cook a second food item, the method comprising:
utilizing a steamer insert apparatus comprising:
a steaming platform, the steaming platform being generally round and configured to self-adjust and to suspend from a rim of a cooking pot, the steaming platform being located within the cooking pot in a suspended manner to provide a surface area on which to place a first food item for steaming; and
an operably coverable opening defined in the steaming platform and through which to access a second food item to cook in water located below the steaming platform;
placing the steaming platform within the cooking pot;
placing a second food item within the cooking pot by passing the second food item through the operably coverable opening of the steaming platform;
heating the water in the cooking pot to cook the second food item and to create steam to rise to the steaming platform;
placing a first food item upon the steaming platform so that it will be steamed; and
removing the second food item, once cooked, through the operably coverable opening in the steaming platform.

15. The method of claim 14, further comprising:
utilizing at least one risible extension, wherein the steamer insert apparatus further comprises at least one risible extension connected to the steaming platform to pivot from the steaming platform and lift upwardly and remain upright above the operably coverable opening and upon which to place the first food item when the first food item is larger in diameter than the cooking pot;
raising the at least one risible extension; and
placing the first food item upon the steaming platform and over the at least one risible extension so that it will be steamed.

16. The method of claim 14, further comprising:
utilizing a pair of risible extensions connected to the steaming platform, offset one from another by approximately ninety degrees to pivot from the steaming platform and lift upwardly and remain upright above the operably coverable opening and upon which to place the first food item when the first food item is larger in diameter than the cooking pot;
utilizing an interlock notch defined in each of the pair of risible extensions such that when both risible extensions are lifted into the upright position, the interlock notches hold the risible extensions in place one to another;
raising the pair of risible extensions;
interlocking the pair of risible extensions with the interlock notch defined in each of the pair of risible extensions; and
placing the first food item upon the steaming platform and over the pair of risible extensions so that it will be steamed.

17. The method of claim 14, further comprising:
placing a dish containing a heatable item in the operably coverable opening of the cooking pot;
wherein the operably coverable opening is configured to receive the dish containing the heatable item within the cooking pot and within the operably coverable opening of the steaming platform to heat the heatable item within the dish.

18. The method of claim 14, further comprising:
covering the operably coverable opening;
wherein the steaming platform is comprised of a plurality of grill grates;
wherein the plurality of plurality of grill grates includes at least a portion of operably movable grates, such that the movable grates are operably moveable to cover and uncover the operably coverable opening.

19. An adjustable steaming grill comprising:
a steaming platform, the steaming platform being generally round and configured to self-adjust and to suspend from a rim of a cooking pot, the steaming platform being located within the cooking pot in a suspended manner to provide a surface area on which to place a first food item for steaming;
an operably coverable opening defined in the steaming platform and through which to access a second food item to cook in water located below the steaming platform;
a pair of risible extensions connected to the steaming platform, offset one from another by approximately ninety degrees to pivot from the steaming platform and lift upwardly and remain upright above the operably coverable opening and upon which to place the first food item when the first food item is larger in diameter than the cooking pot; and
an interlock notch defined in each of the pair of risible extensions such that when both risible extensions are lifted into the upright position, the interlock notches hold the risible extensions in place one to another.

20. The adjustable steaming grill of claim 19, further comprising:
a plurality of support legs, hingedly connected to the steaming platform, to suspend the steaming platform inside the cooking pot from the rim;
a plurality of handles, each handle defined by a connection of a pair of the plurality of support legs, wherein the plurality of support legs are grouped in pairs, each pair collectively forming the handle by which the steaming platform is lifted in and out of the cooking pot.
a plurality of hooks, each hook defined at an upper end of each of the plurality of support legs, wherein the hook is configured to suspend from the rim of the cooking pot;
a plurality of lid resting arms, each lid resting arm defined at an upper end of each of the plurality of support legs and facing inwardly when placed in the cooking pot, wherein the plurality of lid resting arms collectively provide a place upon which to rest a lid of the cooking pot, and wherein the placement of the lid upon the plurality of lid resting arms prevents the cooking pot and lid from touching directly and provides a vent area between the cooking pot and the lid; and
a heat abatement material disposed upon the plurality of handles to provide a grip area for a user when the steamer insert apparatus is heated.
